(19) United States
(12) Patent Application Publication
(10) Pub. No.: US 2014/0015734 A1
(43) Pub. Date: Jan. 16, 2014

(54) Antenna Apparatus

(71) Applicant: Wistron NeWeb Corporation, Hsinchu (TW)

(72) Inventors: Chia-Tien LI, Hsinchu (TW); Sheng-Chih SUN, Hsinchu (TW)

(21) Appl. No.: 13/931,435

(22) Filed: Jun. 28, 2013

(30) Foreign Application Priority Data
Jul. 13, 2012 (TW) 101125363

(51) Int. Cl. H01Q 1/50

(52) U.S. Cl. CPC H01Q 1/50
USPC 343/906

(57) ABSTRACT

An antenna apparatus includes a cable structure, a feed fitting, a ground fitting, and an antenna. The cable structure includes a feed segment and a ground segment, wherein the feed segment and the ground segment are arranged along an axial direction of the cable structure. The feed fitting and the ground fitting respectively electrically fit the feed segment and the ground segment. The antenna includes a body, a feed holding portion and a ground holding portion, wherein the body extends along the axial direction of the cable structure, the feed holding portion and the ground holding portion are arranged on the body along the axial direction, and the feed holding portion and the ground holding portion electrically clamp the feed fitting and the ground fitting, respectively.

### BACKGROUND OF THE INVENTION

1. Field of the Invention

The present invention generally relates to an antenna apparatus. Particularly, the present invention relates to an antenna apparatus that can increase assembling efficiency and can be introduced to an automation process.

2. Description of the Prior Art

Communication technology utilizes mediums to transmit signals from a transmission end to a receiving end, wherein communication technology at least includes wire communication technology and wireless communication technology. Particularly, wireless communication technology generally provides convenience to people and is applied to network, telephone, laptop, tablet, or other mobile devices for fast information transmission.

In practical applications, wireless technology utilizes antenna modules to radiate electric signals for transmitting information, wherein the antenna module needs to connect a coaxial cable, and the coaxial cable is used for transmitting electric signals. In addition, RD firms try to research the connection method between the coaxial cable and the antenna module so as to simplify the assembling process. Most of the conventional connection methods utilize metal welding for connection, wherein metal welding can be manual metal welding or automatic metal welding. However, manual metal welding has faults of labor costs and low assembling efficiency; automatic metal welding is hard to be automatized.

some RD firms try to directly connect the coaxial cable and the antenna module bypassing the soldering process. However, a core wire and a ground weaving net of the coaxial cable easily fork or separate, so that the coaxial cable cannot easily connect the antenna module, reducing the assembling efficiency and radiation yield. For the above reasons, the conventional antenna module still has many defects.

### SUMMARY OF THE INVENTION

It is an object of the present invention to provide an antenna apparatus, which can increase assembling efficiency and can be introduced to an automation process.

In one aspect, the present invention provides an antenna apparatus, which has a plurality of holding portions to increase assembling efficiency.

In another aspect, the present invention provides an antenna apparatus, which utilizes a plurality of fittings to increase degree of component connection.

In one embodiment, the antenna apparatus of the present invention includes a cable structure, a feed fitting, a ground fitting, and an antenna. In addition, the cable structure includes a feed segment and a ground segment, wherein the feed segment and the ground segment are arranged along an axial direction of the cable structure. In practical applications, the feed fitting and the ground fitting respectively electrically fit the feed segment and the ground segment.

It is noted that the antenna includes a body, a feed holding portion, and a ground holding portion, wherein the body extends along the axial direction of the cable structure, the feed holding portion and the ground holding portion are arranged on the body along the axial direction, and the feed holding portion and the ground holding portion electrically clamp the feed fitting and the ground fitting, respectively. In an embodiment, the body includes a ground portion and a radiation portion, wherein the ground portion extends along the axial direction and is vertically bent from a side parallel to the axial direction to form a cable holding portion, so that the cable holding portion, the ground holding portion, and the feed holding portion are sequentially arranged along the axial direction. The body is bent from the side in a transverse direction to form a geometric plate serving as the radiation portion, and the feed holding portion is formed on the radiation portion.

In one embodiment, the antenna apparatus of the present invention includes a cable structure and an antenna. In addition, the cable structure includes a feed segment and a ground segment, wherein the feed segment and the ground segment are arranged along an axial direction of the cable structure. The antenna includes a body, a feed holding portion, and a ground holding portion, wherein the body extends along the axial direction of the cable structure, the feed holding portion and the ground holding portion are arranged on the body along the axial direction. In addition, the feed holding portion electrically contacts the feed segment, and the ground holding portion electrically clamps the ground segment.

In comparison with prior arts, the antenna apparatus of the present invention utilizes the fittings and the holding portions to connect the cable structure on the antenna so as to simplify assembling process. In addition, the present invention provides the antenna apparatus, which has various types of the feed fitting and the feed holding portion corresponding to the feed fitting, and also provides various types of the ground fitting and the ground holding portion corresponding to the ground fitting so as to replace conventional solder connection method. In practical applications, the antenna apparatus can be disposed with various types of fittings and holding portions to be introduced to an automatic assembling process.

The detailed descriptions and the drawings thereof below provide further understanding about the advantage and the spirit of the present invention.

### BRIEF DESCRIPTION OF THE DRAWINGS

FIG. 1 is an exploded view of the embodiment of the antenna apparatus of the present invention;

FIG. 2 is a schematic view of the embodiment of the cable structure connecting the feed fitting and the ground fitting of the present invention;

FIG. 3 is a schematic view of the embodiment of the antenna apparatus of the present invention;

FIG. 4 is a schematic view of another embodiment of the antenna apparatus of the present invention;

FIG. 5 is a schematic view of another embodiment of the present invention, wherein the cable structure connects the feed fitting and the ground fitting;

FIG. 6 is a schematic view of an embodiment of the antenna apparatus of the present invention;

FIG. 7 is a schematic view of an embodiment of the antenna apparatus of the present invention;

FIG. 8 is a schematic view of another embodiment of the present invention, wherein the cable structure connects the feed fitting and the ground fitting;

FIG. 9 is a schematic view of another embodiment of the antenna apparatus of the present invention;

FIG. 10A is an exploded view of another embodiment of the antenna apparatus of the present invention; and

FIG. 10B is a schematic view of the embodiment of the antenna apparatus of FIG. 10A after assembly.

### DETAILED DESCRIPTION OF THE PREFERRED EMBODIMENT

According to one embodiment, the present invention provides an antenna apparatus. In the embodiment, the antenna apparatus can be used in laptops, tablet computers, all-in-one systems, TVs, home computers, or routers for transmitting communication data.

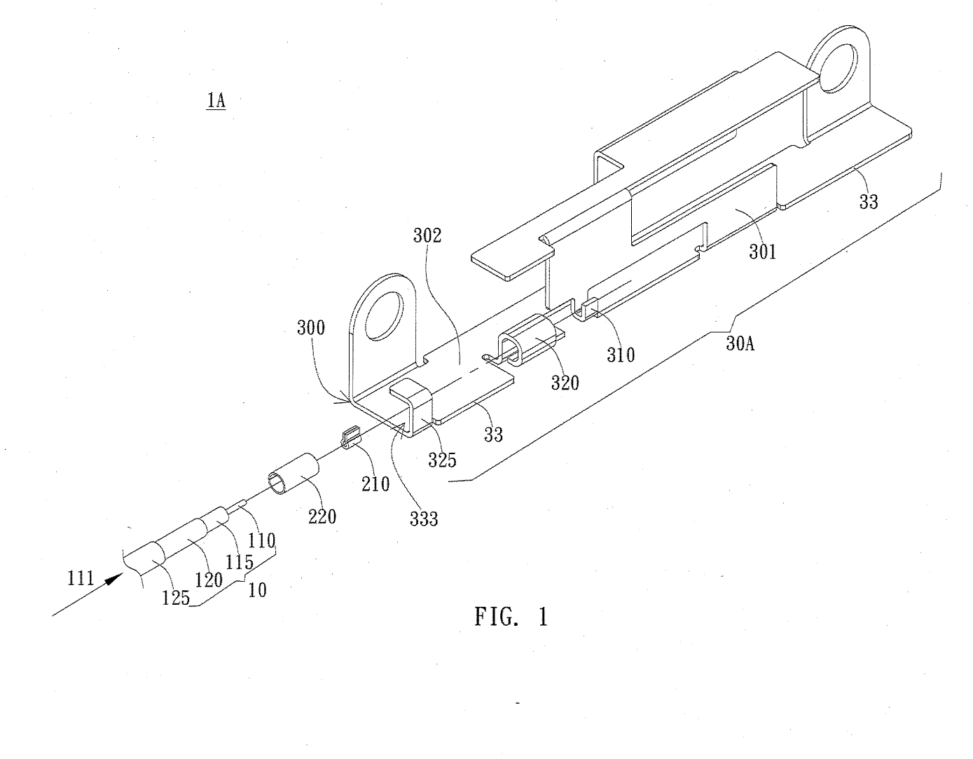

Please refer to FIG. 1; FIG. 1 is an exploded view of the embodiment of the antenna apparatus of the present invention. As shown in FIG. 1, the antenna apparatus 1A includes a cable structure 10, a feed fitting 210, a ground fitting 220, and an antenna 30A. The cable structure 10 includes a feed segment 110 and a ground segment 120, wherein the feed segment 110 and the ground segment 120 are arranged along an axial direction 111 of the cable structure 10. It is noted that the axial direction 111 is a major axis direction or an extending direction of a long side of the cable structure 10. Particularly, the feed segment 110 is an exposed wire for transmitting electric signals; the ground segment 120 is an exposed conducting weave net or other types of conducting layers for providing ground connection.

In practical applications, the cable structure 10 further has an insulating inner layer 115 and an insulating outer layer 125, wherein the insulating inner layer 115 is disposed between the feed segment 110 and the ground segment 120, and the insulating outer layer 125 covers the wire and the conducting weave net. In other words, the cable structure 10 can be a coaxial cable, wherein the feed segment 110 and the ground segment 120 are distributed along the radial direction from inner to outer. The insulating inner layer 115 and the insulating outer layer 125 can avoid short circuit of signals and provide the insulating protection. In addition, the length of the feed segment 110 preferably protrudes out of the ground segment 120 along the axial direction 111.

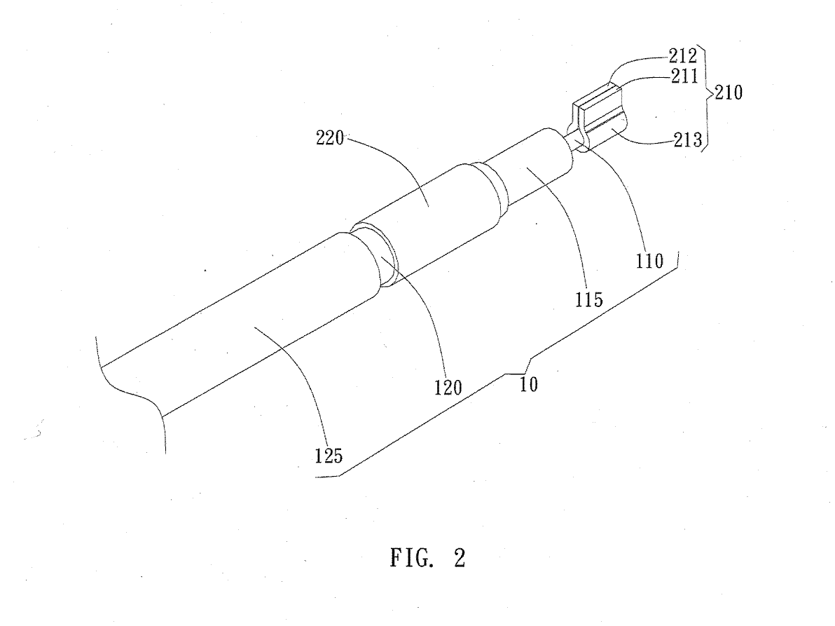

Please refer to FIG. 2; FIG. 2 is a schematic view of the embodiment of the cable structure connecting the feed fitting 210 and the ground fitting 220 of the present invention. As shown in FIG. 2, the feed fitting 210 and the ground fitting 220 respectively electrically fit the feed segment 110 and the ground segment 120. In the embodiment, the ground fitting 220 is a sleeve and fits the ground segment 120, so that an inner diameter of the ground fitting 220 is matched with an outer diameter of the ground segment 120. In other words, the ground fitting 220 can avoid the ground segment 120 separating or forking and can increase ground connection between the cable structure 10 and the antenna 30A.

For example, the ground fitting 220 can be a copper ring, aluminum ring, stannum ring, or other conducting rings. In other embodiments, the ground fitting 220 can be formed by dipping into metal or by immersing in metal, not limited to the embodiment. In the embodiment, the ground fitting 220 is the copper ring, and the feed fitting 210 is a presser. As shown in FIGS. 1 and 2, the feed fitting 210 (the presser) is bent to form a clamping slot for clamping the feed segment 110, so that an inner diameter of the feed fitting 210 is matched with an outer diameter of the feed segment 110. In addition, the feed fitting 210 (the presser) has a first wind plate 211, a second wind plate 212, and a loop 213, wherein the loop 213 is curled to form the clamping slot and extends to form the first wind plate 211 and the second wind plate 212 respectively on two ends of the loop 213.

As shown in FIG. 1, the antenna 30A includes the body 300, the feed holding portion 310, and the ground holding portion 320, wherein the body 300 includes the radiation portion 301 and the ground portion 302. In the embodiment, the ground portion 302 is vertically bent from the side 33 to form a buckle structure serving as the ground holding portion 320, and the buckle structure has a cross section of C-shape, U-shape, or other surrounding-shapes. Particularly, the ground portion 302 is vertically bent from the side 33 to form the buckle structure, and a normal direction of the cross section of the buckle structure is parallel the axial direction 111.

In addition, the body 30A is bent from the side 33 in a transverse direction to form a geometric plate serving as the radiation portion 301, and the feed holding portion 310 is formed on the radiation portion 301. In particular, the body 30A is bent in the transverse direction of the side 33 or in the transverse direction of the axial direction 111 to form the geometric body. It is noted that the shape of the geometric body is designed according to radiating specification of the antenna 30A, not limited to the embodiment. In the embodiment, the feed holding portion 310 and the ground holding portion 320 are integrally disposed on the antenna 30A.

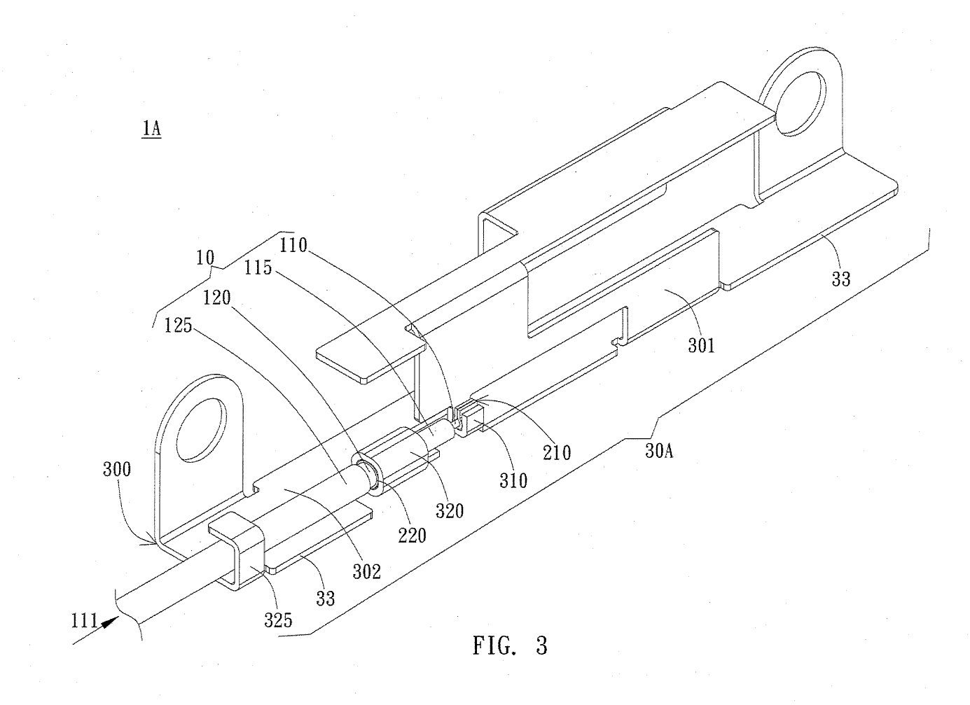

Please refer to FIG. 3; FIG. 3 is a schematic view of the embodiment of the antenna apparatus 1A of the present invention. As shown in FIGS. 1 and 3, an end of the radiation portion 301 (the geometric plate) surrounds the axial direction 111 of the cable structure 10 and is bent to form a groove serving as the feed holding portion 310. In the embodiment, the feed holding portion 310 has a cross section of C-shape, U-shape, or other groove-shapes, wherein the normal direction of the cross section is preferably parallel to the axial direction 111. In addition, the ground portion 302 extends along the axial direction 111 and vertically bent from the side 33 parallel to the axial direction 111 to form the cable holding portion 325, so that the ground holding portion 320 (the buckle structure) and the cable holding portion 325 form a passage 333. In the embodiment, the cable holding portion 325 and the ground portion 302 have a cross section of L-shape, but not limited to the embodiment. In practical applications, the cable holding portion 325 squeezes the cable structure 10 to generate stress, so that the cable structure 10 is clamped on the antenna 30A.

Particularly, the cable holding portion 325, the ground holding portion 320, and the feed holding portion 310 are arranged along the axial direction 111, and the cable structure 10 extends into the passage 333 to connect the antenna 30A. In other words, the body 300 extends along the axial direction 111 of the cable structure 10, wherein the feed holding portion 310 and the ground holding portion 320 are arranged on the body 30A along the axial direction 111 and respectively connect the feed segment 110 and the ground segment 120 of the cable structure 10 by means of the feed fitting 210 and the ground fitting 220. In addition, a groove opening of the feed holding portion 310 is opposite to an opening of the buckle structure of the ground holding portion 320, so that the cable structure 10 can be firmly fitted on the antenna 30A when the cable structure 10 extends into the passage 333. In other words, the groove opening of the feed holding portion 310 and the opening of the buckle structure of the ground holding portion 320 are respectively formed on the opposite sides of a diameter of the cable structure 10. As shown in FIGS. 2 and 3, the first wind plate 211 and the second wind plate 212 partially protrude out of the feed holding portion 310 when the feed segment 110 is fed into the loop 213 and the loop 213 is clamped by the feed holding portion 310.

Please refer to FIG. 3, the feed holding portion 310 and the ground holding portion 320 are electrically connected to the feed fitting 210 and the ground fitting 220, respectively. It is noted that an inner diameter of the cable holding portion 325 is larger than an inner diameter of the ground holding portion 320, and the inner diameter of the ground holding portion 320 is larger than an inner diameter of the feed holding portion 310. It is noted that an inner wall of the feed holding portion 310 contacts an outer wall of the feed fitting 210 to generate electrical connection. An inner wall of the ground holding portion 320 contacts an outer wall of the ground fitting 220 to generate electrical connection. In the embodiment, the inner wall of the feed holding portion 310 preferably wrapps around the outer wall of the feed fitting 210 to generate electrical connection; the inner wall of the ground holding portion 320 preferably wrapps around the outer wall of the ground fitting 220 to generate electrical connection.

Furthermore, the inner diameter and the outer diameter (or the thickness) of the feed fitting 210 are determined according to a distance between inner wall of the feed holding portion 310 and the feed segment 110. The inner diameter and the outer diameter (or the thickness) of the ground fitting 220 are determined according to a distance between the inner wall of the ground holding portion 320 and the ground segment 120. In addition, the thickness of the feed fitting 210 can be determined according to the hardness or toughness of the feed fitting 210 and the stress which the feed holding portion 310 and the feed segment 110 apply to the feed fitting 210. In other words, the thickness of the ground fitting 220 can be determined according to the hardness or toughness of the ground fitting 220 and the stress which the ground holding portion 320 and the ground segment 120 apply to the ground fitting 220.

In other embodiments, a solder layer can be disposed between the ground fitting 220 and the ground segment 120, wherein the ground fitting 220 and the ground segment 120 are soldered by the solder layer. In practical applications, the solder layer is disposed on the outer wall of the ground segment 120 by dipping into metal or by immersing in metal, so that the solder layer and the conducting weave net (the ground segment 120) form a ground composite metal layer to avoid the conducting weave net separating. In other embodiments, the solder layer can replace the ground fitting 220; the ground fitting is not limited to the embodiment.

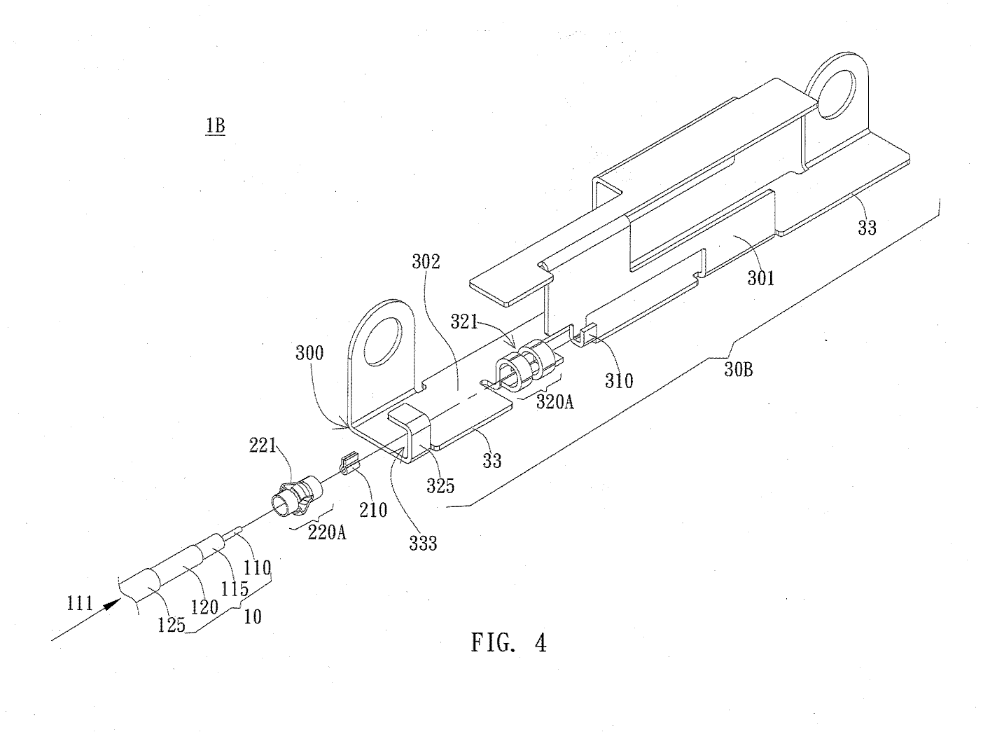

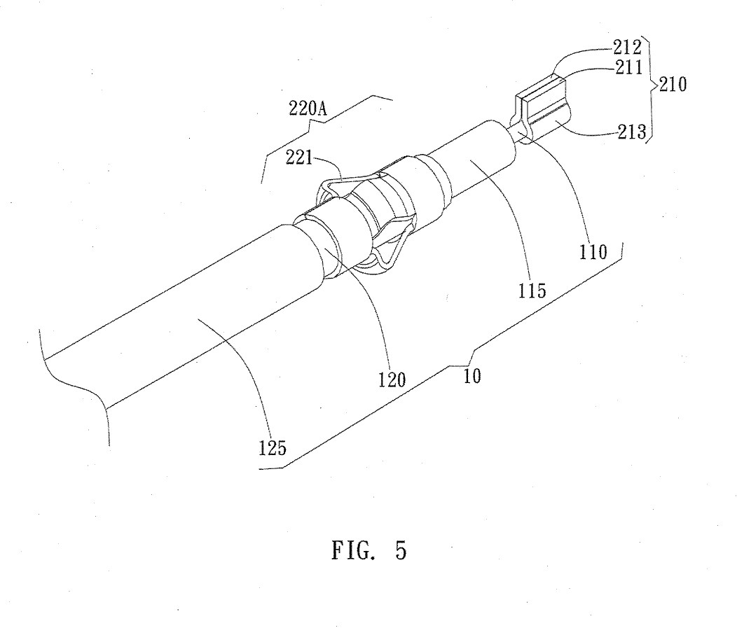

Please refer to FIG. 4; FIG. 4 is a schematic view of another embodiment of the antenna apparatus of the present invention. As shown in FIG. 4, the antenna apparatus 1B includes the antenna 30B, and the ground holding portion 320A is formed with a slit 321 along an extending direction of the ground holding portion 320A. In particular, the extending direction is a bending extension direction of the ground holding portion 320A, wherein the bending extension direction is parallel to a normal plane of the axial direction 111. In other embodiments, the antenna 30B has a plurality of ground holding portions 320 adjacent to each other. For example, the antenna 30B can has two ground holding portions 320, wherein a gap is formed between ground holding portions, but not limited to the embodiment. In addition, please refer to FIG. 5; FIG. 5 is a schematic view of another embodiment of the present invention, wherein the cable structure 10 connects the feed fitting 210 and the ground fitting 220A. As shown in FIGS. 4 and 5, compared to the ground fitting 220 of FIG. 1, the antenna apparatus 1B includes the ground fitting 220A, wherein the ground fitting 220A has at least one elastic protruding portion 221. In practical applications, the amount of the elastic protruding portions 221 can be disposed according to requirement and is not limited thereto.

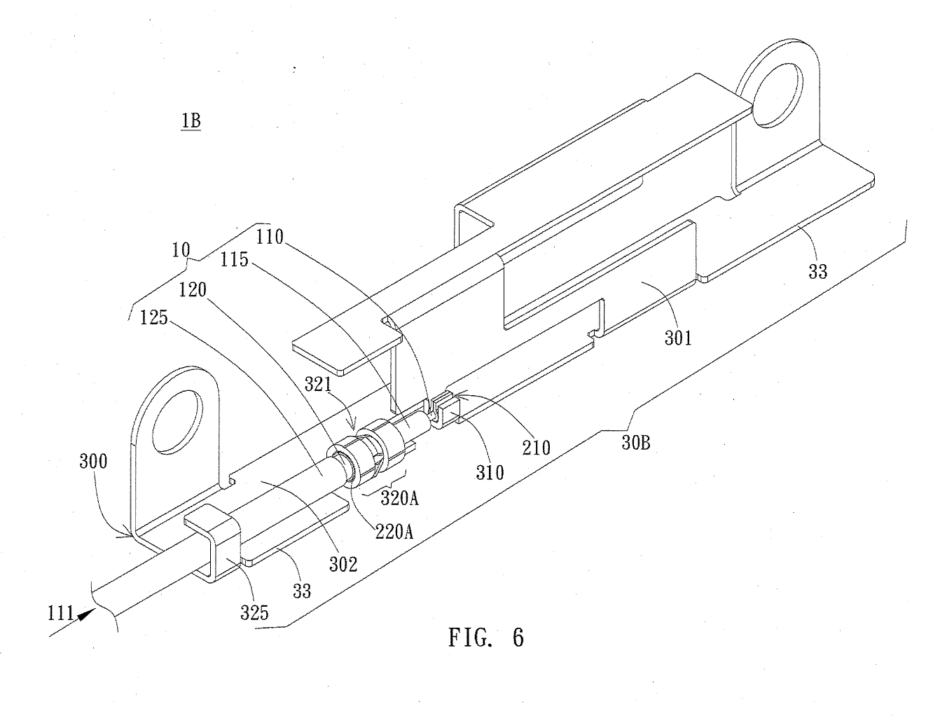

Please refer to FIG. 6; FIG. 6 is a schematic view of the embodiment of the antenna apparatus 1B of the present invention. As shown in FIGS. 5 and 6, the ground fitting 220A has four elastic protruding portions 221, and the elastic protruding portions 221 compressibly extends into the ground holding portion 320A and engages with the slit 321. In addition, the elastic protruding portions 221 are preferably to be integrally disposed on the ground fitting 220A, and material of the elastic protruding portions 221 is preferably elastic metal. Compared to the antenna apparatus 1A, the antenna apparatus 1B of FIG. 6 includes the ground fitting 220A, wherein the ground fitting 220A has at least one elastic protruding portion 221, so that the cable structure 10 and the antenna 30B have better ground connection so as to increase the stress that the ground holding portion 320A clamps the ground segment 120.

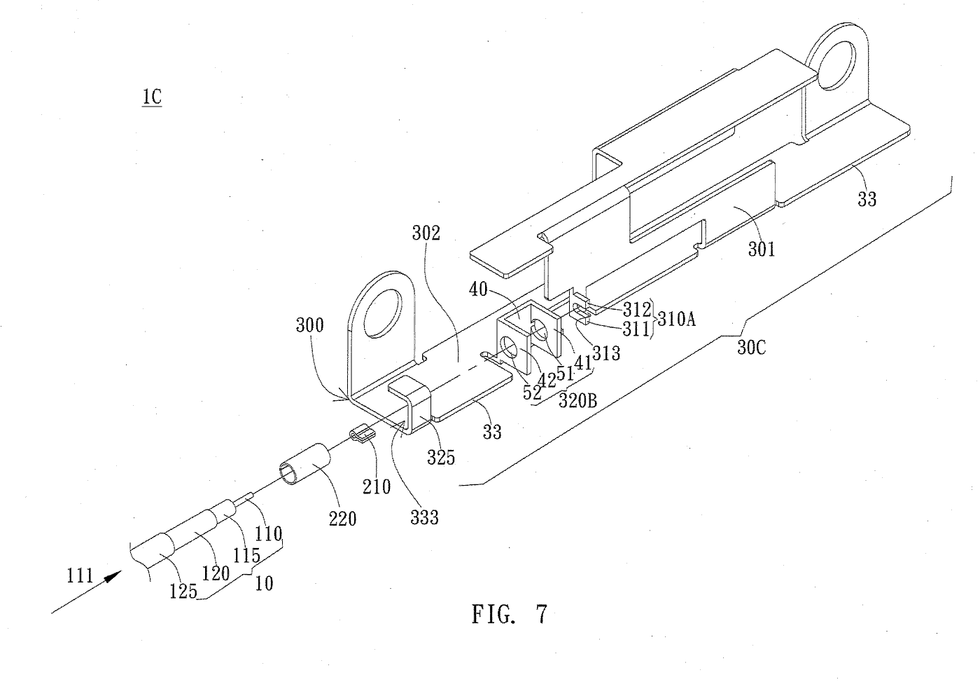

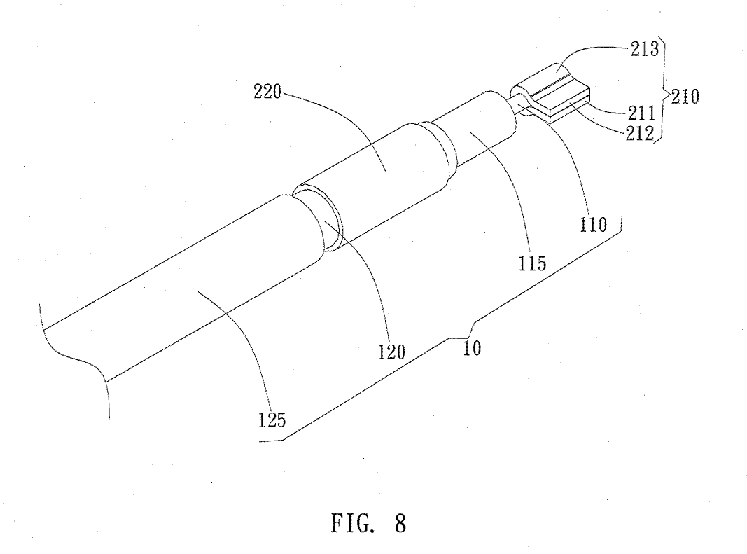

Please refer to FIGS. 7 and 8; FIG. 7 is a schematic view of the embodiment of the antenna apparatus 1C of the present invention; FIG. 8 is a schematic view of another embodiment of the present invention, wherein the cable structure 10 connects the feed fitting 210 and the ground fitting 220. As shown in FIG. 7, the antenna apparatus 1C includes the antenna 30C, wherein the ground portion 302 is vertically bent from the side 33 to form an arm plate 40, two sides of the arm plate 40 are vertically extended to form a first ear plate 41 and a second ear plate 42 serving as the ground holding portion 320B. The first ear plate 41 and the second ear plate 42 have a first hole 51 and a second hole 52, respectively. In the embodiment, the first ear plate 41 and the second ear plate 42 of the ground holding portion 320 are extended vertically from two sides of the arm plate 40, but not limited to the embodiment. It is noted that central axes of the first hole 51 and the second hole 52 are parallel to the axial direction 111. In addition, the cable structure is connected to the antenna 30C through the ground fitting 220 and the feed fitting 210. In practical applications, compared to the ground holding portion 320 or 320A, the first ear plate 41 and the second ear plate 42 of the ground holding portion 320B can respectively surround the circumference of the ground fitting 220, so that the ground segment 120 of the cable structure is electrically connected to the ground portion 302 of the antenna 30C.

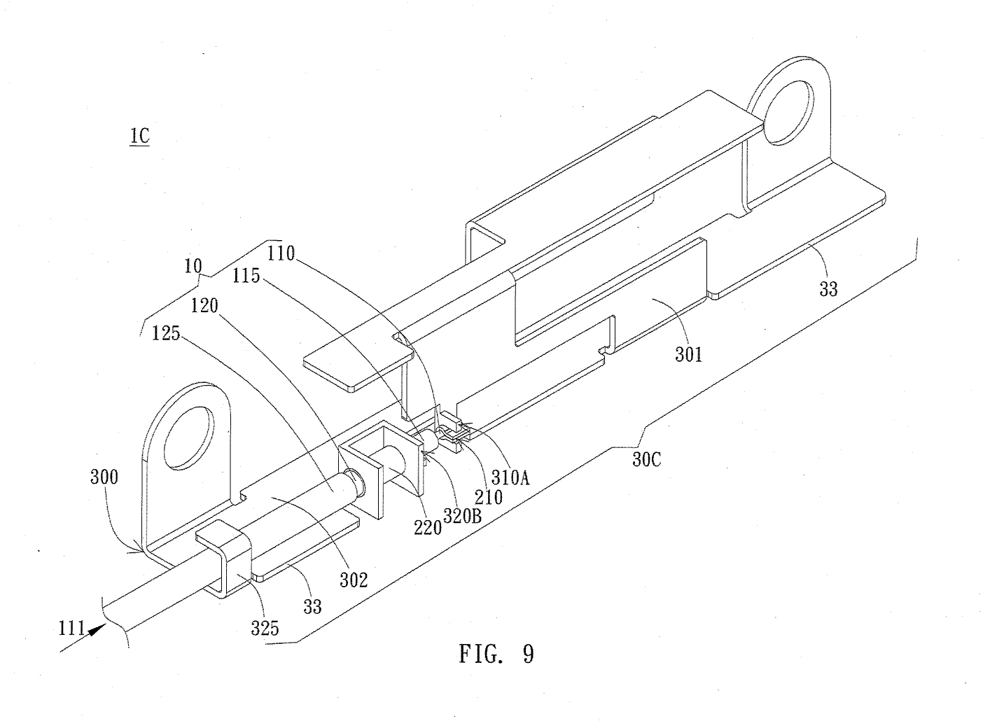

It is noted that an end of the radiation portion 301 (the geometric plate) extends from two sides of the axial direction 111 to form a first arm plate 311 and a second arm plate 312, wherein a recess 313 is formed between the first arm plate 311 and the second arm plate 312. The first arm plate 311, the second arm plate 312, and the recess 313 form the feed holding portion 310A. In other words, the opening of the recess 313 is along one of the radial direction of the axial direction 111. Please refer to FIG. 9; FIG. 9 is a schematic view of another embodiment of the antenna apparatus of the present invention. As shown in FIGS. 8 and 9, the first wind plate 211 and the second wind plate 212 of the feed fitting 210 are toward the extending direction of the first arm plate 311 and the second arm plate 312, and the loop 213 is disposed in the recess 313. In other words, the disposing direction of the first wind plate 2111 and the second wind plate 212 of the feed fitting 210 is determined according to the position of the opening of the recess 313 of the feed holding portion 310A, so that the feed fitting 210 and the feed segment 110 are precisely clamped by the feed holding portion 310A.

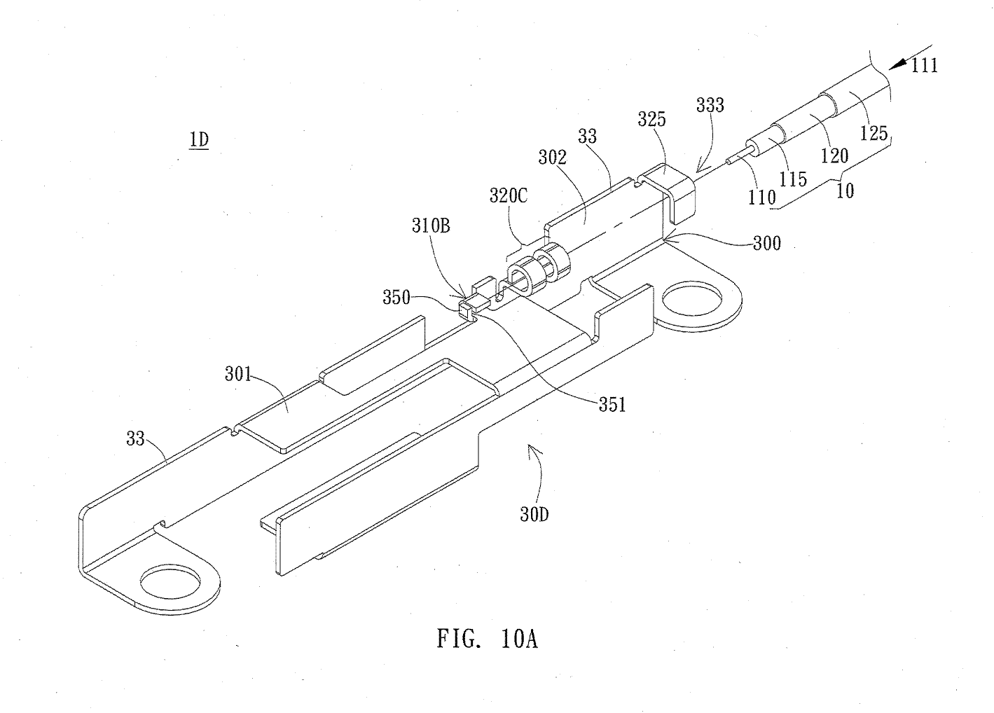

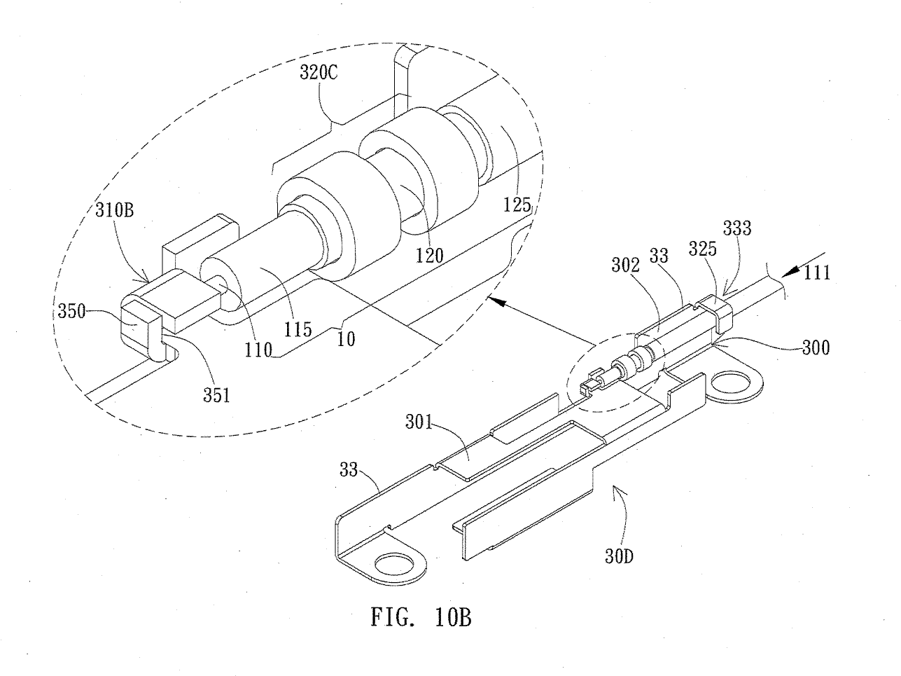

In addition, please refer to FIGS. 10A and 10B; FIG. 10A is an exploded view of another embodiment of the antenna apparatus of the present invention, FIG. 10B is a schematic view of the embodiment of the antenna apparatus of FIG. 10A after assembly. As shown in FIG. 10A, compared to the antenna apparatuses 1A˜1C, the antenna 1D does not include the feed fitting and the ground fitting. As shown in FIG. 10B, the feed holding portion 310B of the antenna 30D electrically contacts the feed segment 110, and the ground holding portion 320C electrically clamps the ground segment 120. In other words, the ground holding portion 320C directly clamps the ground segment 120 to generate stress, so that the ground segment 120 is clamped on the ground holding portion 320C.

In the embodiment, the feed holding portion 310B includes a stopper 350, wherein the stopper 350 has a stopper surface 351, wherein the stopper surface 351 is normal to the axial direction 111 and faces the feed segment 110, and the feed segment 110 perpendicularly contacts the stopper surface 350. In particular, the cable structure 10 extends into the passage 333, and the stopper 350 interferes with the feed segment 110 so as to increase assembling efficiency of the antenna apparatus 1D. Furthermore, the stopper surface 351 physically contacts the feed segment 110 to electrically connect the cable structure 10. In other words, the stopper 350 physically stops the procession of the feed segment 110, and the ground holding portion 320C directly utilizes the stress to clamp the ground segment 120, so that the cable structure 10 is engaged on the antenna apparatus 1D.

In comparison with prior arts, the antenna apparatus of the present invention utilizes the fittings and the holding portions to connect the cable structure on the antenna so as to simplify assembling process. In addition, the antenna apparatus has various types of the feed fitting 210 and the feed holding portion 310/310A corresponding to the feed fitting 210, and also has various types of the ground fitting 220/220A and the ground holding portion 320/320A/320B corresponding to the ground fitting 220/220A so as to replace conventional solder connection method. In practical applications, the antenna apparatus can be disposed with various types of fittings and holding portions to be introduced to the automatic assembling process.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. An antenna apparatus, comprising:
a cable structure comprising a feed segment and a ground segment, wherein the feed segment and the ground segment are arranged along an axial direction of the cable structure;
a feed fitting and a ground fitting respectively electrically fitting the feed segment and the ground segment; and
an antenna comprising a body, a feed holding portion, and a ground holding portion, wherein the body extends along the axial direction of the cable structure, the feed holding portion and the ground holding portion are arranged on the body along the axial direction, and the feed holding portion and the ground holding portion electrically clamp the feed fitting and the ground fitting, respectively.

2. The antenna apparatus of claim 1, wherein the feed holding portion and the ground portion are integrally disposed on the antenna.

3. The antenna apparatus of claim 1, wherein the body comprises:
a ground portion extending along the axial direction and vertically bent from a side parallel to the axial direction to form a cable holding portion, so that the cable holding portion, the ground holding portion, and the feed holding portion are sequentially arranged along the axial direction.

4. The antenna apparatus of claim 3, wherein the ground portion is vertically bent from the side to form a buckle structure serving as the ground holding portion.

5. The antenna apparatus of claim 3, wherein the body further comprises:
a radiation portion, wherein the body is bent from the side in a transverse direction to form a geometric plate serving as the radiation portion, and the feed holding portion is formed on the radiation portion.

6. The antenna apparatus of claim 5, wherein an end of the geometric plate surrounds the axial direction of the cable structure and is bent to form a groove serving as the feed holding portion.

7. The antenna apparatus of claim 4, wherein the buckle structure and the cable holding portion form a passage.

8. The antenna apparatus of claim 3, wherein the ground fitting is a sleeve and fits the ground segment, so that an inner diameter of the ground fitting is matched with an outer diameter of the ground segment; an inner wall of the ground holding portion wraps around an outer wall of the ground fitting to generate electrical connection.

9. The antenna apparatus of claim 3, wherein the ground holding portion is formed with a slit along an extending direction of the ground holding portion.

10. The antenna apparatus of claim 9, wherein the ground fitting has at least one elastic protruding portion, and the at least one elastic protruding portion compressibly extends into the ground holding portion and engages with the slit.

11. The antenna apparatus of claim 3, wherein the ground portion is vertically bent from the side to form an arm plate, two sides of the arm plate are vertically extended to form a first ear plate and a second ear plate serving as the ground holding portion, the first ear plate and the second ear plate have a first hole and a second hole, respectively.

12. The antenna apparatus of claim 5, wherein an end of the geometric plate extends from two sides of the axial direction to form a first arm plate and a second arm plate, wherein a recess is formed between the first arm plate and the second arm plate, and the first arm plate, the second arm plate, and the recess form the feed holding portion.

13. The antenna apparatus of claim 1, wherein the feed fitting is a presser, and the presser is bent to form a clamping slot for clamping the feed segment, so that an inner diameter of the feed fitting is matched with an outer diameter of the feed segment; an inner wall of the feed holding portion wrapps around an outer wall of the feed fitting to generate electrical connection.

14. The antenna apparatus of claim 13, wherein the presser has a loop, a first wind plate, and a second wind plate, the loop is curled to form the clamping slot and is extended to form the first wind plate and the second wind plate respectively on two ends of the loop; the first wind plate and the second wind plate partially protrude out of the feed holding portion when the feed segment is fed into the loop and the loop is clamped by the feed holding portion.

15. The antenna apparatus of claim 1, wherein a solder layer is disposed between the ground fitting and the ground segment, wherein the ground segment is soldered by the solder layer.

16. The antenna apparatus of claim 1, wherein the feed segment and the ground segment are distributed along a radial direction from inner to outer.

17. An antenna apparatus, comprising:
a cable structure comprising a feed segment and a ground segment, wherein the feed segment and the ground segment are arranged along an axial direction of the cable structure;
an antenna comprising a body, a feed holding portion, and a ground holding portion, wherein the body extends along the axial direction of the cable structure, the feed holding portion and the ground holding portion are arranged on the body along the axial direction; the feed holding portion electrically contacts the feed segment, and the ground holding portion electrically clamps the ground segment.

18. The antenna apparatus of claim 17, wherein the feed holding portion comprises:
a stopper having a stopper surface, wherein the stopper surface is normal to the axial direction and faces the feed segment, and the feed segment perpendicularly contacts the stopper surface.
